(19) United States
(12) Patent Application Publication
(10) Pub. No.: US 2010/0044449 A1
(43) Pub. Date: Feb. 25, 2010

(54) SERVICE REMINDERS FOR BUILDING CONTROL SYSTEMS

(75) Inventor: Patrick Tessier, Maple Grove, MN (US)

Correspondence Address: HONEYWELL/CST;Patent Services, 101 Columbia Road, P.O. Box 2245, Morristown, NJ, 07962-2245, US

(73) Assignee: Honeywell International Inc., Morristown, NJ (US)

(21) Appl. No.: 12/194,331

(22) Filed: Aug. 19, 2008

(51) Int. Cl. G05D 23/00; G06F 15/16

(52) U.S. Cl. 236/94; 709/207

(57) ABSTRACT

A building controller configured to display a service reminder that reminds a user to service one or more HVAC components of an HVAC system. In some cases, the building controller includes a control module configured to determine when to display the service reminder based, at least in part, on a geographical region of the building controller and seasonal data for the geographical region. The control module may display the service reminder before an HVAC component of the HVAC system is expected to switch from being dormant during a first part of the year to being active during a second part of the year.

### FIELD

The present invention relates generally to building controllers, and more particularly, to methods and devices for providing service reminders for building controller.

### BACKGROUND

Building control systems often include heating, ventilation, and/or air conditioning (HVAC) systems to control the comfort level within a building. Many building control systems include a HVAC controller that activates and deactivates one or more HVAC components of the HVAC system to affect and control one or more environmental conditions within the building. These environmental conditions can include, but are not limited to, temperature, humidity, and/or ventilation. In many cases, the HVAC controller may include, or have access to, one or more sensors, and may use parameters provided by the one or more sensors to control the one or more HVAC components to achieve one or more programmed or set environmental conditions.

In some installations, the one or more HVAC components may include one or more seasonal HVAC components that are active only during certain seasons of the year, and dormant the remainder of the year. For example, heating HVAC components may be active during relatively cool seasons, and may remain dormant or largely dormant during relatively warm seasons. Similarly, cooling HVAC components may be active during relatively warm seasons, and may remain dormant or largely dormant during relatively cool seasons.

In some circumstances, one or more of the seasonal HVAC components may become degraded or even fail either at the tail end of their previous active season or during the dormant off-season. As a result, the user may not realize that a seasonal HVAC component of their HVAC system has become degraded or failed until after the active season arrives and the seasonal HVAC component is again activated and needed. Because this may happen to many users in the same geographical region at the same time, HVAC contractors can become overwhelmed with service calls. In some cases, the HVAC contractors cannot attend to all of these service calls in a timely manner, resulting in some users having to wait a significant period of time before their HVAC systems can be serviced. This can reduce the comfort within the building for an extended period of time.

### SUMMARY

The following summary is provided to facilitate an understanding of some of the innovative features unique to the present invention and is not intended to be a full description. A full appreciation of the invention can be gained by taking the entire specification, claims, drawings, and abstract as a whole.

The present invention relates generally to building controllers, and more particularly, to methods and devices for providing service reminders to users of the building controllers. To help ensure proper operation of the one or more seasonal HVAC components of an HVAC system, it is contemplated that a building controller may provide a service reminder that reminds the user to schedule service for a seasonal HVAC component prior to the arrival of the active season for that seasonal HVAC component. For example, the building controller may display a service reminder that reminds the user to schedule service for a heating HVAC component before the heating season arrives in a certain geographical region (e.g. later summer/early fall). Likewise, the building controller may display a service reminder that reminds the user to schedule service for a cooling HVAC component before the cooling season arrives in a certain geographical region (e.g. later winter/early spring). In some cases, the building controller may accept an indication of the geographic location of the building controller, which in some cases, may help improve the timeliness of the service reminders by taking into account the particular weather/temperature patterns of the users geographical region.

### BRIEF DESCRIPTION

The invention may be more completely understood in consideration of the following description of various illustrative embodiments of the invention in connection with the accompanying drawings, in which:

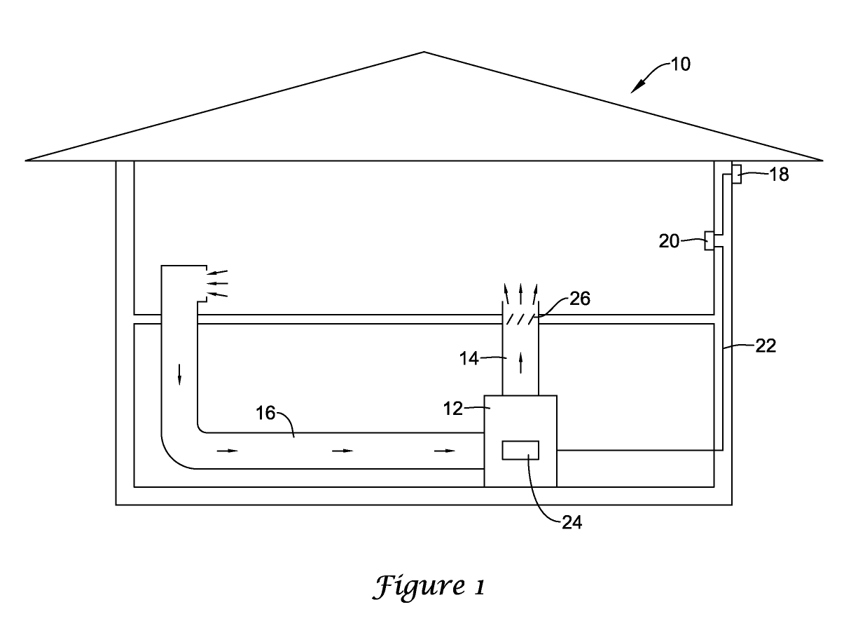

FIG. 1 is a schematic diagram of an illustrative heating, ventilation, and air conditioning (HVAC) system in a building or other structure;

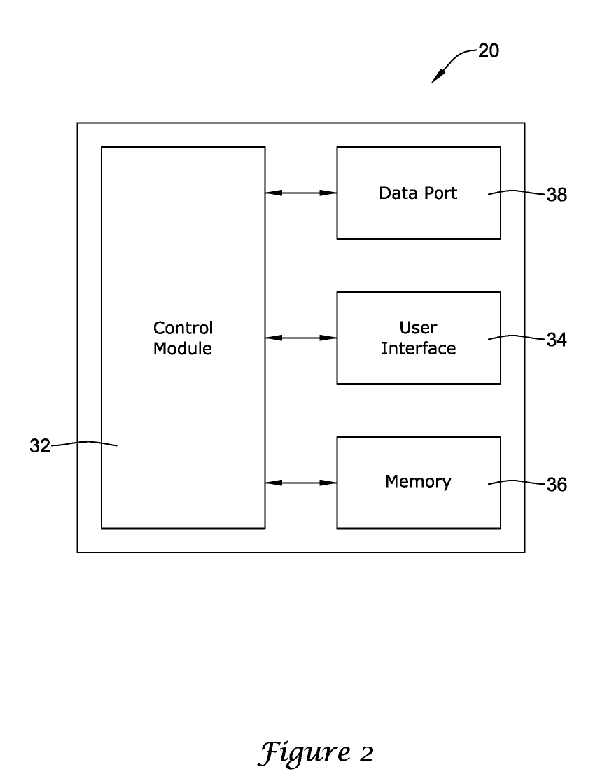

FIG. 2 is a block diagram of the illustrative HVAC controller of FIG. 1;

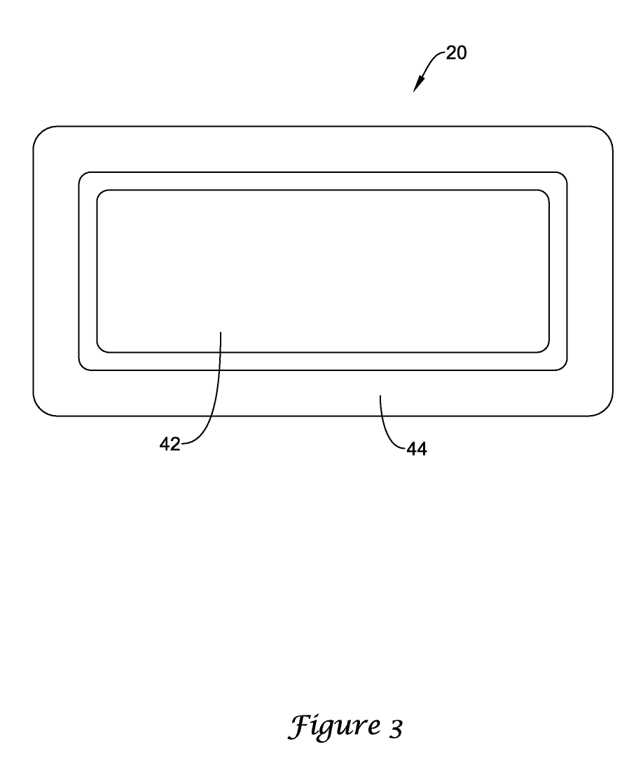

FIG. 3 is a front perspective view of an illustrative HVAC controller of FIG. 2; and

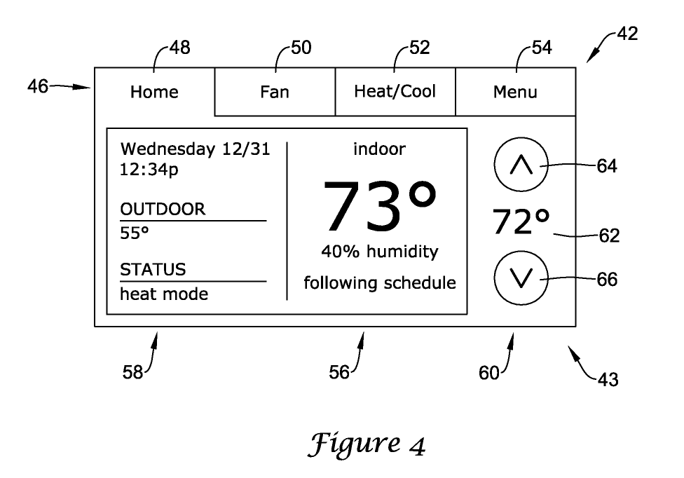

FIGS. 4-7 are pictorial views of illustrative screens that may be displayed on the HVAC controller of FIG. 3.

### DESCRIPTION

The following description should be read with reference to the drawings wherein like reference numerals indicate like elements throughout the several views. The description and drawings show several illustrative embodiments.

FIG. 1 is a schematic diagram of an illustrative heating, ventilation, and air conditioning (HVAC) system in a building or other structure. While FIG. 1 shows a typical force air type HVAC system, other types of HVAC systems may be used including hydronic systems, boiler systems, radiant heating systems, or any other suitable type of HVAC system, as desired. The HVAC system of FIG. 1 includes one or more HVAC components 12, a system of vents or ductwork 14 and 16, and an HVAC controller 20. In the illustrative embodiment, the one or more HVAC components 12 may include, but are not limited to, a furnace, a boiler, a heat pump, an air conditioning unit, a humidifier, a dehumidifier, an air exchanger, an air cleaner, and/or the like.

In the illustrative HVAC system of FIG. 1, the one or more HVAC components 12 can provide heated air (and/or cooled air) via the ductwork throughout the building 10 or other structure. As illustrated, the one or more HVAC components 12 may be in fluid communication with every room and/or zone in the building 10 or other structure via the ductwork 14 and 16. In operation, when a heat call signal is provided by the HVAC controller 20 via wire(s) 22 (or wireless signals), one or more HVAC components 12 (e.g. forced warm air furnace) may be activated to supply heated air to one or more rooms and/or zones within the building 10 or other structure via supply air ducts 14. The heated air may be forced through supply air duct 14 by a blower or fan 24. In this example, the cooler air from each zone may be returned to the one or more HVAC components 12 (e.g. forced warm air furnace) for heating via return air ducts 16. Similarly, when a cool call signal is provided by the HVAC controller 20 via wire(s) 22 (or wireless signals), the one or more HVAC components 12 (e.g. air conditioning unit) may be activated to supply cooled air to one or more rooms and/or zones within the building 10 or other structure via supply air ducts 14. The cooled air may be forced through supply air duct 14 by the blower or fan 24. In this example, the warmer air from each zone may be returned to the one or more HVAC components 12 (e.g. air conditioning unit) for cooling via return air ducts 16.

In some cases, the system of vents or ductwork 14 and 16 can include one or more dampers 26 to regulate the flow of air, but this is not required. For example, one or more dampers 26 may be coupled to the HVAC controller 20 and can be coordinated with the operation of one or more HVAC components 12. The HVAC controller 20 may be able to actuate damper 26 to an open position, a closed position, and/or a partially open position to modulate the flow of air from the one or more HVAC components 12 to a room and/or zone in the building or other structure 10.

It is contemplated that the HVAC controller 20 may be configured to control the comfort level of the building or structure 10 by activating and deactivating the one or more HVAC components 12. In some cases, the HVAC controller 20 may be a thermostat, such as, for example, a wall mountable thermostat, but this is not required. In one illustrative embodiment, the HVAC controller 20 may be a 24 volt-alternating current (VAC) powered HVAC controller. In this embodiment, the HVAC controller 20 may receive power from a 24 VAC step-down transformer, which may typically be provided near the HVAC components 12 and may be part of the HVAC system for supplying 24 VAC power to some or all of the one or more HVAC components 12. Alternatively, the HVAC controller 20 may be powered locally, such as via a battery.

In some embodiments, an outdoor air sensor 18 may be provided to sense a parameter of the outdoor air adjacent to the building or structure 10. In some cases, the outdoor air sensor 18 may be configured to sense an outside temperature, an outside humidity, and/or any other outside air parameter, as desired. The outdoor air sensor 18 may communicate the sensed outdoor air parameter to the HVAC controller 20. In some cases, the HVAC controller 20 may be configured to control the comfort level of the building or structure 10, at least in part, using the outside temperature, the outside humidity, and/or other outside air parameter sensed by the outdoor air sensor 18. In some cases, the HVAC controller 20 may be configured to display the outside temperature, the outside humidity, and/or other outside air parameter sensed by the outdoor air sensor 18 to a user.

In some embodiments, some of the one or more HVAC components 12 may be active for one or more seasons of the year, and dormant or largely dormant for one or more other seasons of the year. For example, cooling components, such as the air conditioning unit, may be active during the summer season and may be dormant or largely dormant during the winter season. Similarly, heating components, such as the forced air warm furnace, may be active during the winter season and may be dormant or largely dormant during the summer season. These are merely illustrative, and it is to be understood that the activation and dormancy of the one or more HVAC components may vary according to the weather patterns at the installation.

FIG. 2 is a block diagram of the illustrative HVAC controller 20 of FIG. 1. As discussed previously, HVAC controller 20 may be a thermostat, such as a wall mountable thermostat, but this is not required in all embodiments. In the illustrative embodiment, HVAC controller 20 includes a control module 32, a user interface 34, a memory 36, and a data port 38. The HVAC controller 20 may include a temperature and/or other sensors, and/or be coupled to a temperature and/or other sensor, as desired.

The control module 32 of FIG. 2 may be configured to help control the comfort level (e.g. heating, cooling, ventilation, air quality, etc.) of at least a portion of the building or structure 10 by controlling whether and when one or more HVAC components 12 are activated. In some cases, the control module 32 may include a processor (i.e. microprocessor or microcontroller) configured to operate in accordance with a control algorithm that accepts a number of operating parameters and controls the one or more HVAC components 12 accordingly. Control module 32 may be configured to control and/or set one or more HVAC functions, such as, for example, HVAC schedules, temperature setpoints, humidity setpoints, trend logs, timers, environment sensing, and/or other HVAC functions or programs, as desired.

In the illustrative embodiment of FIG. 2, user interface 34 may be any suitable interface that permits control module 32 to display and/or solicit information as well as permit a user to enter data and/or other settings, as desired. In some cases, user interface 34 may allow a user or contractor to program and/or modify one or more control parameters of HVAC controller 20, such as programming, set point, time, equipment status and/or parameters, as desired.

In some cases, the user interface 34 may allow a user or contractor to input a geographical region that corresponds to the geographic location where the particular HVAC controller 20 is installed. The geographical region for the HVAC controller 20 may be input as, for example, a zip code, a street address, longitudinal and/or latitudinal coordinates, a city name, a state name, and/or any other suitable geographic indication, as desired.

The user interface 34 may also allow a user or contractor to input contractor information, as well as other information, if desired. When so provided, the HVAC contractor information may include, but is not limited to, a contractor name, a contractor logo, a contractor phone number, a contractor website, a contractor email address, a contractor street address, and/or any other suitable dealer or contractor information, as desired. In some instances, the user interface 34 may include a touch screen, a liquid crystal display (LCD) panel and keypad, a dot matrix display, a computer, buttons and/or any other suitable interface, as desired.

In some embodiments, the user interface 34 may be configured to display one or more operating parameters of the HVAC controller 20, one or more environmental parameters (i.e. outdoor temperature, indoor temperature, outdoor humidity, indoor humidity, and the like parameters), and one or more service reminders. In some cases, the service reminders may include, for example, HVAC component service reminders. In some cases, the user interface 34 may be configured to display dealer or contractor information at the same time or a subsequent time to the service reminder(s), but this is not required.

The illustrative HVAC controller 20 of FIG. 2 includes a memory 36 to store desired information, such as the aforementioned HVAC schedules, temperature setpoints, humidity setpoints, trend logs, timers, environmental settings, geographical region, dealer or contractor information, and/or any other settings and/or information as desired. It is contemplated that control module 32 may retrieve stored information, and in some cases store information within memory 36. Memory 36 may include any suitable type of memory, such as, for example, random-access memory (RAM), read-only member (ROM), electrically erasable programmable read-only memory (EEPROM), Flash memory, or any other suitable memory, or combinations of memories, as desired.

In some cases, the memory 36 may be configured to store geographical dependent seasonal data. For example, in some cases, memory 36 may store seasonal data for various geographical regions, which may be identified by, for example, zip codes. The seasonal data may include, for example, average daily, weekly, or monthly temperature data throughout the year at various geographical regions, average daily, weekly, or monthly humidity data throughout the year at various geographical regions, average daily, weekly, or monthly sun angle throughout the year at the various geographical regions, and/or any other suitable seasonal data, and in particular, seasonal data that affects or otherwise influences the heat load on buildings. In some cases, the seasonal data may be stored in a tabular database, a look-up table, one or more equations, and/or in any other suitable format, as desired. Furthermore, in one case, it is contemplated that the seasonal data may include one or more predetermined dates for each of a plurality of geographical locations, and the control module 32 may issue the service reminder(s) on the stored predetermined date(s), if desired.

Although not required, the HVAC controller 20 may include a data port 38. Data port 38 may be configured to communicate with controller 32 and may, if desired, be used to either upload information to controller 32 or to download information from controller 32. Information that can be uploaded or downloaded may include values of operating parameters, seasonal data for various geographical regions, the geographical region of the particular HVAC controller 20, and/or any other suitable information, as desired. In some cases, data port 38 may be used to upload and/or download information pertaining to an HVAC dealer or service contractor.

In some cases, data port 38 may be a wireless port such as a Bluetooth™ port or any other wireless protocol, but this is not required. In some cases, data port 38 may be a wired port such as a serial port, a parallel port, a CAT5 port, a USB (universal serial bus) port, or the like. In some instances, data port 38 may be a USB port and may be used to download and/or upload information from a USB flash drive. In some embodiments, data port 38 may be configured to access a local area network or world wide web via an Ethernet port, an 802.11 interface, or any other suitable interface, as desired. In some cases, the data port 38 may access the network or World Wide Web to find seasonal data for a specified geographical region, dealer or service contractor information, or any other data or information as desired.

In some embodiments, outdoor air sensor 18 may be coupled to control module 32 to monitor one or more outdoor air parameters, such as, for example the outdoor air temperature and/or outdoor humidity. The control module 32 may compare the outdoor air parameter(s) to the stored or accessed seasonal data, and determine if the current sensed condition deviates from the stored seasonal data for the particular geographical region entered for the HVAC controller 20.

In operation, the control module 32 may determine or predict when to display a HVAC component service reminder to a user via the user interface 34 according to: (1) the geographical region entered for the HVAC controller 20; and (2) the seasonal data. In some cases, the service reminder(s) may remind the user to service one or more HVAC components prior to having the first seasonal demand for the components. For example, the HVAC controller 20 may issue a service reminder when one or more HVAC components are still dormant or largely dormant. The service reminder(s) may be issued and displayed, for example, one week, two weeks, three weeks, four weeks, five weeks, six weeks, or any other time before the HVAC components are expected to switch from being dormant or largely dormant to being active. In other cases, the service reminder(s) may be issued and displayed, for example, when the seasonal data (i.e. average daily, weekly, or monthly temperature) stored in memory is a predetermined temperature. The predetermined temperature may be a temperature so that the HVAC component service reminder is displayed before the HVAC components are expected to switch from being dormant or largely dormant to being active. For example, the predetermined temperature may be 60 degrees Fahrenheit, 65 degrees Fahrenheit, 70 degrees Fahrenheit, 75 degrees Fahrenheit, or any other suitable temperature, as desired. It is also contemplated that multiple predetermined temperatures to issue multiple reminders and/or different predetermined temperature for different seasons may be used, as desired.

In one illustrative embodiment, if the control module 32 is programmed to display the service reminder at least one week before the one or more HVAC components are expected to switch from dormant or largely dormant to active, the control module 32 may predict when this switch is likely to occur using the geographical region entered into the HVAC controller 20 and the seasonal data stored in memory 36. The control module 32 may then cause the service reminder(s) to be displayed via the user interface 34 one week before the predicted date. In some cases, the control module 32 may also cause the user interface to display the HVAC dealer or service contractor information at the same time, or subsequent to, displaying the service reminder, if desired.

In another illustrative embodiment, if the control module 32 is programmed to display the service reminder when the stored seasonal data has a predetermined average daily, weekly, or monthly temperature value. The control module 32 may predict when this temperature is likely to occur using the geographical region entered into the HVAC controller 20 and the seasonal data stored in memory 36. The control module 32 may then cause the service reminder(s) to be displayed via the user interface 34 on the predicted date. In some cases, the control module 32 may also cause the user interface to display the HVAC dealer or service contractor information at the same time, or subsequent to, displaying the service reminder, if desired.

In some cases, the control module 32 may adjust the predicted date based upon the sensed outdoor air temperature, sensed outdoor humidity and/or other sensed parameter(s). Alternatively, or in addition, the control module 32 may adjust the predicted date based upon current weather data accessed via the World Wide Web. In one example, if the outdoor air temperature and/or current or predicted weather data indicate that the outdoor temperature is unseasonable warm or cold, the control module 32 may adjust the predicted date to an earlier date and display the service reminder(s) at the earlier date. When so provided, this may help ensure that the service reminder is displayed before the dormant or largely dormant HVAC component is actually activated or needed even under unseasonably warm or cold conditions.

In a specific example, the control module 32 may perform trending of the current seasonal data. The trending may include the control module 32 comparing the current outdoor air temperature sensed by the outdoor temperature sensor to the average daily temperature stored in the memory and tracking the difference. If the difference between the sensed temperature and the average daily temperature exceeds an offset temperature (i.e. 5 degrees Fahrenheit, 10 degrees Fahrenheit, or any other offset) for a number of days (i.e. five days, one week, two weeks, or any other number of days), the control module 32 may predict, using the difference between the stored temperature data and the sensed temperature data, when the predetermined temperature will be reached and the control module 32 may issue the service reminder for the heating component of the HVAC system sooner than would otherwise be predicted based on the seasonal data for the particular geographical region. For example, if the trending data determines that the current seasonal temperature is 5 degrees Fahrenheit cooler in the fall, and the predetermined temperature is 65 degrees Fahrenheit, the control module 32 may issue the service reminder(s) for the HVAC components when the stored seasonal data has a daily, weekly, or monthly average of 70 degrees Fahrenheit. It is to be understood that the foregoing temperature values are merely illustrative and are not meant to be limiting in any manner. Furthermore, it is contemplated that any suitable algorithm may be used to determine when the service reminder(s) is to be displayed when using the outdoor air temperature sensor, as desired.

In another example, if early in the fall season, the outdoor air temperature and/or current or predicted weather data indicated a daily low temperature that is less than a threshold value (e.g. 50 degrees), or a series of daily low temperatures that are less than a threshold value, the control module 32 may issue a service reminder for the heating component of the HVAC system sooner than would otherwise be predicted based on the seasonal data for the particular geographical region.

FIG. 3 is a front perspective view of an illustrative HVAC controller 20 of FIG. 2. As illustrated, HVAC controller 20 includes a display 42 that is disposed within a housing 44. In some cases, display 42 may be a touch screen LCD display, but this is not required. If desired, display 42 may be a dot matrix touch screen LCD display, but again this is not required. A dot matrix touch screen LCD display is a touch screen LCD that permits images such as letters, numbers, graphics, icons and the like to be displayed anywhere on the LCD, rather than being confined to predetermined locations such as is the case with a fixed segment LCD. Housing 44 may be formed of any suitable material, such as a polymeric material.

In some cases, HVAC controller 20 may be configured to provide substantial display and/or programming functionality. FIGS. 4-7 are pictorial views of illustrative screens that may be displayed on the HVAC controller 20. FIG. 4, for example, shows an illustrative home screen that may be displayed by HVAC controller 20. In some cases, a home screen may be a screen that can be accessed by a top level navigational menu. In some cases, a home screen may be a screen that is displayed by HVAC controller 20 as a default display, or when no other data entry is underway. A home screen may, if desired, display one or more parameters relating to environmental conditions such as indoor and/or outdoor temperature and/or humidity, expected weather conditions, current set point(s), the status of any equipment that is at least partially controlled by HVAC controller 20, and/or any other suitable parameter or data element as desired.

In FIG. 4, HVAC controller 20 is displaying on display 42 a home screen 43 that includes a navigational bar generally designated as 46, which may be considered as providing top level navigation. In the illustrative embodiment, navigation bar 46 includes a HOME button 48, a FAN button 50, a HEAT/COOL button 52 and a MENU button 54. However, these are only illustrative. FIG. 4 is an example of a screen that may be displayed after a user has pushed HOME button 48. When a user touches the FAN button 50, one or more screens may be accessed to view, modify and/or set fan settings. When a user touches the HEAT/COOL button 52, one or more screens may be accessed to view, modify and/or set the heat and/or cool settings of the HVAC controller 20. When a user touches the MENU button 48, one or more screens may be accessed to view and/or adjust various settings and/or parameters of the HVAC controller 20, as desired.

In the illustrative embodiment, home screen 43 may be considered as having two or more regions. For example, home screen 43 may include a first region 56 and a second region 58. In some instances, the first region 56 may display one or more of a current temperature reading, a current indoor humidity, a schedule status, and the like. As illustrated, the second region 58 may display one or more of a date and time, an outdoor temperature reading, an outdoor humidity reading, an equipment status, and the like.

In the illustrative embodiment, home screen 43 may also include a third region 60, which may be used for displaying and/or adjusting a parameter value such as a set point. In some cases, for example, third region 60 may include a set point parameter 62, an up arrow 64 and a down arrow 66. The value of set point parameter 62 may be increased or decreased using, as necessary, up arrow 64 and/or down arrow 66. In the illustrative embodiment, the parameter 62 may be a current set point of the HVAC controller 20, but any suitable parameter may be used, as desired.

As illustrated, second region 58 may refer to a left-hand section of home screen 43, third region 60 may refer to a right-hand section of home screen 43 and first region 56 may refer to a center section of home screen 43 that is between second region 58 and third region 60. In other embodiments, the first region 56, second region 58 and/or third region 60 may be rearranged horizontally or, in some cases, may be arranged vertically above or below the other regions within home screen 43, as desired. In yet another embodiment, less or more than three regions may be displayed on the home screen 43, as desired.

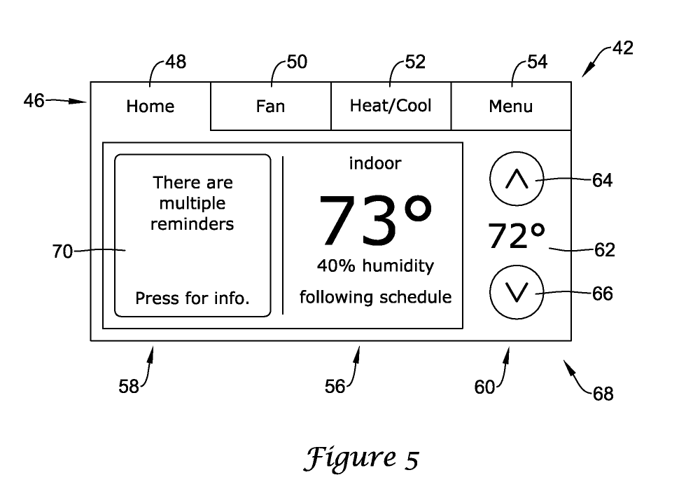

In the illustrative embodiment, the second region 58 may also function to display one or more service reminders, such as shown in FIG. 5. FIG. 5 shows in schematic form, a reminder notification screen 70 in the second region 58. In the illustrative embodiment, the reminder notification screen 70 is displayed in the second region 58 when the control module 32 determines that there are one or more active reminder notifications (e.g. service reminders) to be displayed. When no reminder notifications are currently outstanding, the control module 32 may display, for example, the date and time, the outdoor temperature reading, and the equipment status as shown in FIG. 4. In some cases, one or more reminders, such as “Time for Pre-Season Check Out” or the like may be displayed in the reminder notification screen 70 of FIG. 5. In some cases, the reminder may be more specific, such as “Time for Pre-Season Check Out of your Heating Equipment”, or “Time for Pre-Season Check Out of your Cooling Equipment”. In some cases, the reminder notification screen 70 of FIG. 5 may also display contractor contact information, if desired.

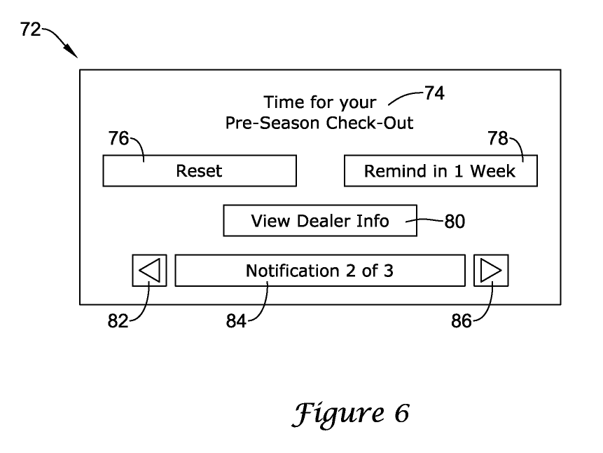

When more than one reminder notifications are active, it is contemplated that a user may touch the reminder notification screen 70 of FIG. 5 to get the screen shown in FIG. 6. FIG. 6 is a pictorial view of an illustrative screen 72 showing the second of three active reminder notifications 74 for HVAC controller 20. As indicated above, and in some cases, screen 72 may be displayed when a user touches reminder notification screen 70 of FIG. 5. As illustrated, screen 72 may include a reminder description 74, a reset button 76, a remind in one week button 78, a view dealer information button 80, arrow buttons 82 and 86, and a notification box 84. As illustrated, the reminder description 74 displays the reminder “Time for your Pre-Season Check-Out”, which indicates to the user that it is time to service one or more of the HVAC components. The Reset button 76 may clear the currently displayed notification reminder from the HVAC controller 20. The Remind in 1 Week button 78 may instruct the HVAC controller 20 to remind the user again of the notification 74 in one week. Arrows 82 and 86 and notification box 84 may allow a user to scroll through a plurality of currently active reminder notifications. The View Dealer Info button 80 may allow a user to view dealer and/or contractor information, such as dealer contact information, stored in the memory 36 of the HVAC controller 20.

In some cases, the reminder notification 74 may be activated and displayed when the controller 20 determines that it is time to have some of the one or more HVAC components serviced. In some cases, this determination may be based, at least in part, on the particular geographical region of the HVAC controller 20, and the seasonal data for that geographical region. In one example, and as described above, reminder notification 74 may be displayed prior to a dormant or largely dormant HVAC component becoming active. In some cases, the reminder notification 74 may be displayed one week, two weeks, three weeks, four weeks, five weeks, six weeks, or any other length of time before the HVAC controller 20 predicts or otherwise determines that the dormant or largely dormant HVAC component becomes active, or the reminder notification 74 may be displayed when the stored seasonal data (i.e. average daily, weekly, or monthly temperature) reaches a predetermined seasonal value (i.e. predetermined temperature).

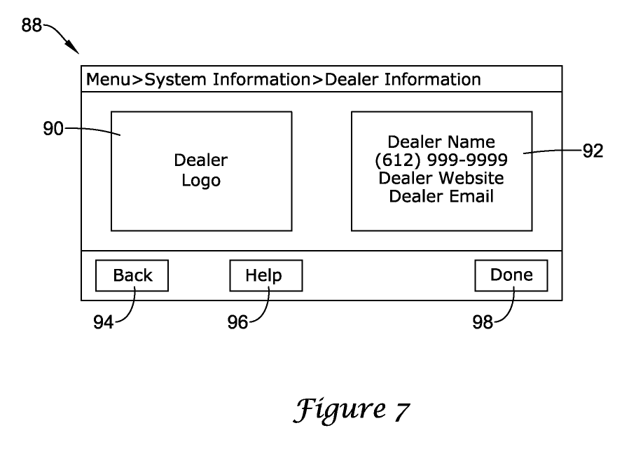

FIG. 7 is a pictorial view of an illustrative screen 88 showing information related to an HVAC dealer or contractor. This screen 88 may be accessed by, for example, touching the “View Dealer Info” button 80 of FIG. 6. In the illustrative embodiment, the HVAC contractor information may include a logo 90 or other image identifying a particular HVAC contractor. Screen 88 may also include a contractor name, a contractor phone number, a contractor website, a contractor email address, and/or other contractor information. This may help the user identify the HVAC contractors contact information in order to schedule and perform service and/or maintenance on one or more of the HVAC components, including those recommended by the service reminder 74 of FIG. 6. In some cases, the contractor information may be stored by the HVAC contractor during installation of the HVAC controller 20. As illustrated, screen 88 includes a Back button 94 to access the previous screen (e.g. screen 72 of FIG. 6), a Help button 96 to access help information, and a Done button 98 to return to the home screen 43 of FIG. 4.

Having thus described the preferred embodiments of the present invention, those of skill in the art will readily appreciate that yet other embodiments may be made and used within the scope of the claims hereto attached. Numerous advantages of the invention covered by this document have been set forth in the foregoing description. It will be understood, however, that this disclosure is, in many respect, only illustrative. Changes may be made in details, particularly in matters of shape, size, and arrangement of parts without exceeding the scope of the invention. The invention's scope is, of course, defined in the language in which the appended claims are expressed.

1. A building controller comprising:
a control module;
a user interface coupled to the control module;
the control module programmed to display one or more service reminders on the display, and also configured to receive an indication of a geographical region of the building controller via the user interface;
a memory coupled to the control module for storing the indication of the geographical region of the building controller, and for storing seasonal data for at least two geographical regions including the geographical region of the building controller; and
wherein the control module determines when to display the one or more service reminders on the user interface based, at least in part, on the geographical region of the building controller received via the user interface and the seasonal data stored in the memory.

2. The building controller of claim 1 wherein the control module is configured to control one or more HVAC components of a building.

3. The building controller of claim 1 wherein the one or more HVAC components have an active state and a dormant state, wherein the one or more HVAC components are in the active state for at least one season of a year, and in a dormant or largely dormant state for at least another season of the year, wherein the control module determines to display the one or more service reminders for the one or more HVAC components before the one or more HVAC components switch from the dormant or largely dormant state to the active state.

4. The building controller of claim 3 wherein the control module determines to display the one or more service reminders for the one or more HVAC components at least one week before the one or more HVAC components switch from the dormant or largely dormant state to the active state.

5. The building controller of claim 1 wherein the control module determines to display the one or more service reminders for the one or more HVAC components when the stored seasonal data for the geographical location reaches a predetermined temperature.

6. The building controller of claim 1 wherein the indication of the geographical region of the building controller is input as a zip code.

7. The building controller of claim 1 further comprising a data port connected to the control module and/or the memory and configured to upload the seasonal data to the memory.

8. The building controller of claim 1 further comprising an outside air sensor coupled to the control module and configured to sense a measure related to the outdoor air temperature, wherein the control module may adjust when to display the one or more service reminders based, at least in part, on the outdoor air temperature.

9. The building controller of claim 1 wherein the memory includes a tabular database including the seasonal data for the at least two geographical regions.

10. The building controller of claim 1 wherein the user interface displays HVAC dealer and/or service contractor data with or subsequent to the one or more service reminders.

11. The building controller of claim 1 wherein the control module is configured to access the World Wide Web to retrieve current weather data, wherein the control module compares the current weather data to the stored seasonal data and adjusts when to display the service reminder accordingly.

12. A method for displaying on a display of a HVAC controller a service reminder to service one or more HVAC components of an HVAC system, wherein the one or more HVAC components are expected to be active during a first part of a year and dormant during a second part of the year, the method comprising:
storing seasonal data for at least two geographical regions in a memory of the HVAC controller;
storing a geographical region of the HVAC controller in the memory of the HVAC controller; and
determining a time at which to display the service reminder, the time based, at least in part, on the stored seasonal data and the stored geographical region of the HVAC controller.

13. The method of claim 12 wherein the time at which to display the service reminder is before the one or more HVAC components are expected to be activated during the first part of the year.

14. The method of claim 13 wherein the time at which to display the service reminder is at least one week before the one or more HVAC components are expected to be activated during the first part of the year.

15. The method of claim 13 wherein the time at which to display the service reminder is when the stored seasonal data for the stored geographical region reaches a predetermined temperature.

16. The method of claim 12 further comprising displaying the service reminder on a display of the HVAC controller.

17. The method of claim 15 further comprising displaying contractor information on the display of the HVAC controller at the same time as the service reminder.

18. The method of claim 15 further comprising displaying contractor information on the display of the HVAC controller subsequent to displaying the service reminder.

19. The method of claim 12 further comprising:
sensing an outdoor temperature;
adjusting the determined time at which to display the service reminder based, at least in part, on the sensed outdoor temperature.

20. The method of claim 12 wherein the geographical region of the HVAC controller is stored as a zip code.

21. A building control system comprising:
an HVAC component that is dormant for one or more seasons and is active for one or more seasons; and
a HVAC controller configured to display a service reminder to service the HVAC component, wherein the reminder is displayed when the HVAC component is still dormant.

22. The building control system of claim 21 wherein the reminder is displayed at a time that is based on a geographical region of the building control system and on seasonal data for the geographical region.

23. The building control system of claim 21 wherein the reminder is displayed when the seasonal data for the geographical region reaches a predetermined seasonal value.
